(19) United States
(12) Patent Application Publication
(10) Pub. No.: US 2008/0076944 A1
(43) Pub. Date: Mar. 27, 2008

(54) Purification of Phosphorus Chelate Ligands

(75) Inventors: Michael Bartsch, Neustadt (DE); Robert Baumann, Mannheim (DE); Gerd Haderlein, Grunstadt (DE); Tobias Aechtner, Mannheim (DE); Jens Scheidel, Hirschberg (DE); Hermann Luyken, Ludwigshafen (DE); Peter Pfab, Neustadt (DE); Wolfgang Siegel, Limburgerhof (DE); Verena Weiskopf, Alsheim (DE)

Correspondence Address: CONNOLLY BOVE LODGE & HUTZ LLP, 1875 EYE STREET, N.W., SUITE 1100, WASHINGTON, DC, 20036, US

(73) Assignee: BASF AKTIENGESELLSCHAFT, Ludwigshafen (DE)

(21) Appl. No.: 11/576,575

(22) PCT Filed: Sep. 30, 2005
(86) PCT No.: PCT/EP05/10561

§ 371 Date: Apr. 3, 2007

(30) Foreign Application Priority Data
Oct. 8, 2004 (DE) 10 2004 049 339.1

(51) Int. Cl. C07F 9/09

(52) U.S. Cl. 568/14

(57) ABSTRACT

A process for purifying phosphorus chelate ligands by extraction, by using polar extractants.

The present invention relates to a process for purifying phosphorus chelate ligands by extraction with polar extractants.

U.S. Pat. No. 6,069,167, U.S. Pat. No. 6,031,120, WO-A-03/44029 and WO-A-03/62171 disclose the selective synthesis of particular chelate ligands by reaction with amine auxiliary bases.

In these syntheses, the ligands are obtained after removal of the amine base hydrochlorides (phase separation or filtration), as a crude solution in a nonpolar solvent, for example toluene. When the ligand is used in the homogeneous catalysis, the nonpolar solvent is often exchanged for a polar solvent. An example to be mentioned here is the homogeneously nickel-catalyzed hydrocyanation of 3-pentenenitrile to ADN, where the polar solvent is also the reactant. In-house investigations have shown that these chelate ligands are stable in nonpolar media, whereas they decompose or rearrange irreversibly in polar media owing to amine and amine hydrochloride traces from the ligand synthesis.

Investigations have shown that the components which induce the rearrangement can be removed by column chromatography on silica gel. However, this form of ligand purification is too costly for an industrial process on the multiton scale.

It is therefore an object of the present invention to develop a suitable inexpensive process for purifying the crude ligand solution and to remedy the disadvantages mentioned above.

Accordingly, a novel and improved process for purifying phosphorus chelate ligands by extraction has been found, which comprises using polar extractants.

The present invention may be carried out as follows:

Phosphorus chelate ligands from syntheses as known from U.S. Pat. No. 6,069,267, U.S. Pat. No. 6,031,120, WO-A-03/44029 and DE-A-102 30 222 may be purified by the purifications described there; the reaction effluents described there are preferably purified directly with a polar extractant at temperatures of from (−20) to 150° C., preferably from (−10) to 120° C., more preferably from 0 to 60° C., and a pressure of from 1 to 5000 kPa, preferably from 10 to 1000 kPa, more preferably from 50 to 500 kPa, in particular from 75 to 250 kPa. For the extraction and phase separation, an advantageous temperature has been found to be at least 0° C., preferably at least 10° C., more preferably at least 20° C., and at most 100° C., preferably at most 80° C., more preferably at most 60° C., and an advantageous pressure has been found to be at least 1 kPa, preferably at least 10 kPa, more preferably 20 kPa and at most 2000 kPa, preferably at most 1000 kPa, more preferably at most 500 kPa.

Suitable polar extractants are all aprotic polar solvents which form two phases with aliphatics and cycloaliphatics, preferably nitrites, dinitriles and dialkylamines, more preferably dinitriles, for example adiponitrile or methylglutaronitrile.

The extraction may be carried out in batchwise, semibatchwise or continuous mode in any suitable apparatus known to those skilled in the art. Preference is given to working in countercurrent extraction columns, mixer-settler units or combinations of mixer-settler units with columns, more preferably in countercurrent extraction columns which are in particular equipped with sheet metal packings as dispersing elements. In a further particularly preferred embodiment, the extraction may be carried out in countercurrent in a compartmented, stirred extraction column. The phase separation may be carried out in one or more apparatuses commonly known per se for such phase separations. In an advantageous embodiment, the phase separation may be carried out, for example, in the extraction apparatus with one or more mixer-settler combinations, or by equipping an extraction column with a calming zone. Depending on the apparatus configuration, the phase separation may also, in a spatial and temporal sense, be viewed as the last part of the extraction. The phase separation may be carried out in one or more apparatuses known to those skilled in the art for such phase separations. In an advantageous embodiment, the phase separation may be carried out in the extraction apparatus, for example in one or more mixer-settler combinations, or by equipping an extraction column with a calming zone.

In a preferred embodiment of the process, the reaction effluent is used as the continuous phase and the polar phase as the disperse phase. This generally shortens the phase separation time and reduces rag formation. However, the reverse dispersion direction, i.e. reaction effluent as continuous phase and hydrocarbon as disperse phase, is also possible. Typically, the dispersion direction more favorable for the separating performance of the extraction apparatus is selected. In a particularly preferred embodiment, the extractant is used as the disperse phase and the reaction effluent of the hydrocyanation as the continuous phase.

Rag refers to a region of incomplete phase separation between upper and lower phase, usually a liquid/liquid mixture in which solids may also be dispersed. Excessive rag formation is undesired, since it hinders the extraction and the extraction apparatus can under some circumstances be flooded by rag, as a result of which it can no longer fulfill its separation task.

The reaction effluent or the prepurified phosphorus chelate ligands may be diluted before or during the extraction or phase separation with an aliphatic or cycloaliphatic hydrocarbon or mixtures thereof, for example hexane isomer mixture, n-hexane, heptane isomer mixture, n-heptane, octane isomer mixture, n-octane, cyclohexane, methylcyclohexane or mixtures thereof, preferably n-heptane, n-octane, cyclohexane, methylcyclohexane or mixtures thereof.

The volume ratio of the phases in the extraction may vary within wide ranges and is generally between 0.01:1 to 10:1, preferably from 0.04:1 to 2.5:1, more preferably from 0.07:1 to 1.5:1.

Suitable phosphorus chelate ligands are ligands of the formula (I)

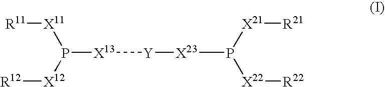

where
X^{11, X}¹², X¹³ are each independently oxygen or a single bond and X¹¹ or X¹² or X¹³=oxygen
X²¹, X²², X²³ are each independently oxygen or a single bond and X²¹ or X²² or X²³=oxygen
R¹¹, R¹² are each independently identical or different, separate or bridged organic radicals
R²¹, R²² are each independently identical or different, separate or bridged organic radicals
Y is a bridging group.

In the context of the present invention, compound (II) is a single compound or a mixture of different compounds of the aforementioned formula.

In a preferred embodiment, X¹¹, X¹², X¹³, X²¹, X²², X²³ may each be oxygen. In such a case, the bridging group Y is bonded to phosphite groups.

In another preferred embodiment, X¹¹ and X¹² may each be oxygen and X¹³ a single bond, or X¹¹ and X¹³ each oxygen and X¹² a single bond, so that the phosphorus atom surrounded by X¹¹, X¹² and X¹³ is the central atom of a phosphonite. In such a case, X²¹, X²² and X²³ may each be oxygen, or X²¹ and X²² may each be oxygen and X²³ a single bond, or X²¹ and X²³ may each be oxygen and X²² a single bond, or X²³ may be oxygen and X²¹ and X²² each a single bond, or X²¹ may be oxygen and X²² and X²³ each a single bond, so that the phosphorus atom surrounded by X²¹, X²² and X²³ may be the central atom of a phosphite, phosphonite or phosphinite, preferably a phosphonite.

In another preferred embodiment, X¹³ may be oxygen and X¹¹ and X¹² each a single bond, or X¹¹ may be oxygen and X¹² and X¹³ each a single bond, so that the phosphorus atom surrounded by X¹¹, X¹² and X¹³ is the central atom of a phosphonite. In such a case, X²¹, X²² and X²³ may each be oxygen, or X²³ may be oxygen and X²¹ and X²² each a single bond, or X²¹ may be oxygen and X²² and X²³ each a single bond, so that the phosphorus atom surrounded by X²¹, X²² and X²³ may be the central atom of a phosphite or phosphinite, preferably a phosphinite.

The bridging group Y is preferably an aryl group which is substituted, for example by C₁-C₄-alkyl, halogen, such as fluorine, chlorine, bromine, halogenated alkyl, such as trifluoromethyl, aryl, such as phenyl, or is unsubstituted, preferably a group having from 6 to 20 carbon atoms in the aromatic system, in particular pyrocatechol, bis(phenol) or bis(naphthol).

The R¹¹ and R¹² radicals may each independently be identical or different organic radicals. Preferred R¹¹ and R¹² radicals are aryl radicals, preferably those having from 6 to 10 carbon atoms, which may be unsubstituted or mono- or polysubstituted, in particular by C₁-C₄-alkyl, halogen, such as fluorine, chlorine, bromine, halogenated alkyl, such as trifluoromethyl, aryl, such as phenyl, or unsubstituted aryl groups.

The R²¹ and R²² radicals may each independently be identical or different organic radicals. Preferred R²¹ and R²² radicals are aryl radicals, preferably those having from 6 to 10 carbon atoms, which may be unsubstituted or mono- or polysubstituted, in particular by C₁-C₄-alkyl, halogen, such as fluorine, chlorine, bromine, halogenated alkyl, such as trifluoromethyl, aryl, such as phenyl, or unsubstituted aryl groups.

The R¹¹ and R¹² radicals may each be separate or bridged.

The R²¹ and R²² radicals may each be separate or bridged.

The R¹¹, R¹², R²¹ and R²² radicals may each be separate, two may be bridged and two separate, or all four may be bridged, in the manner described.

In a particularly preferred embodiment, useful compounds are those of the formula I, II, III, IV and V specified in U.S. Pat. No. 5,723,641.

In a particularly preferred embodiment, useful compounds are those of the formula I, II, III, IV, V, VI and VII specified in U.S. Pat. No. 5,512,696, in particular the compounds used there in examples 1 to 31.

In a particularly preferred embodiment, useful compounds are those of the formula I, II, III, IV, V, VI, VII, VII, IX, X, XI, XII, XIII, XIV and XV specified in U.S. Pat. No. 5,821,378, in particular the compounds used there in examples 1 to 73.

In a particularly preferred embodiment, useful compounds are those of the formula I, II, III, IV, V and VI specified in U.S. Pat. No. 5,512,695, in particular the compounds used there in examples 1 to 6.

In a particularly preferred embodiment, useful compounds are those of the formula I, II, III, IV, V, VI, VII, VII, IX, X, XI, XII, XIII and XIV specified in U.S. Pat. No. 5,981,772, in particular the compounds used there in examples 1 to 66.

In a particularly preferred embodiment, useful compounds are those specified in U.S. Pat. No. 6,127,567 and the compounds used there in examples 1 to 29.

In a particularly preferred embodiment, useful compounds are those of the formula I, II, III, IV, V, VI, VII, VIII, IX and X specified in U.S. Pat. No. 6,020,516, in particular the compounds used there in examples 1 to 33.

In a particularly preferred embodiment, useful compounds are those specified in U.S. Pat. No. 5,959,135, and the compounds used there in examples 1 to 13.

In a particularly preferred embodiment, useful compounds are those of the formula I, II and III specified in U.S. Pat. No. 5,847,191.

In a particularly preferred embodiment, useful compounds are those specified in U.S. Pat. No. 5,523,453, in particular the compounds illustrated there in formula 1, 2, 3, 4, 5, 6, 7, 8, 9, 10, 11, 12, 13, 14, 15, 16, 17, 18, 19, 20 and 21.

In a particularly preferred embodiment, useful compounds are those specified in WO 01/14392, preferably the compounds illustrated there in formula V, VI, VII, VIII, IX, X, XI, XII, XIII, XIV, XV, XVI, XVII, XXI, XXII, XXIII.

In a particularly preferred embodiment, useful compounds are those specified in WO 98/27054.

In a particularly preferred embodiment, useful compounds are those specified in WO 99/13983.

In a particularly preferred embodiment, useful compounds are those specified in WO 99/64155.

In a particularly preferred embodiment, useful compounds are those specified in the German patent application DE 100 380 37.

In a particularly preferred embodiment, useful compounds are those specified in the German patent application DE 100 460 25.

In a particularly preferred embodiment, useful compounds are those specified in the German patent application DE 101 502 85.

In a particularly preferred embodiment, useful compounds are those specified in the German patent application DE 101 502 86.

In a particularly preferred embodiment, useful compounds are those specified in the German patent application DE 102 071 65.

In a further particularly preferred embodiment of the present invention, useful phosphorus chelate ligands are those specified in US 2003/0100442 A1.

In a further particularly preferred embodiment of the present invention, useful phosphorus chelate ligands are those specified in US 2004/062765 A1.

In a further particularly preferred embodiment of the present invention, useful phosphorus chelate ligands are those specified in the German patent application DE-A-10350 333 having the same priority date as the present application and the title “Phosphinite phosphates” to BASF AG.

The process according to the invention allows phosphorus chelate ligands to be obtained which have a content of amine base, amine hydrochloride or mixtures thereof of less than 100 ppm, preferably less than 80 ppm, more preferably less than 60 ppm. In this context, amine bases are, for example, trialkylamines, pyridine bases, dialkylamines, monoalkylamines, preferably methylimidazole, and also the amine hydrochlorides formed therefrom, for example triethylamine hydrochloride and methylimidazole hydrochloride, preferably methylimidazole hydrochloride.

These are suitable as ligands for the hydrocyanation of butadiene to pentenenitriles, the isomerization of 2-methyl-3-butenenitrile to 3-pentenenitrile and the hydrocyanation of 3-pentenenitrile to adiponitrile. The phosphorus chelate ligands (for example chelate phosphites known from U.S. Pat. No. 5,981,772 and U.S. Pat. No. 6,127,567, chelate phosphonites known from WO-A-99/64155, WO-A-99/13983, DE-A-101 50 285 and DE-A-102 07 165, chelate phosphinites known from U.S. Pat. No. 5,523,453, U.S. Pat. No. 5,693,843 and DE-A-101 50 286, and chelate phosphite phosphinites DE-A-103 50 999) may be converted to the catalysts, for example, with the aid of nickel(0).

### EXAMPLES

All examples with ligands 1, 2 and 3 were carried out under an argon atmosphere (protective gas atmosphere):

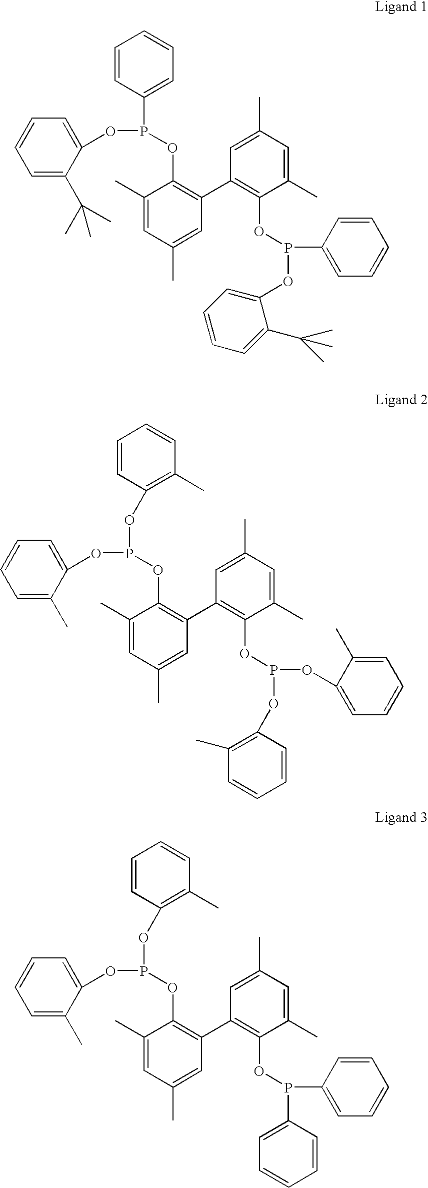

### Example 1

### Extraction with Adiponitrile and Subsequent and Heating of Ligand 1

600 g of a 60% toluenic solution of ligand 1 (crude ligand), prepared according to DE-A-102 30 222, were admixed with 600 g of methylcyclohexane and extracted at room temperature 6 times with in each case 60 g of adiponitrile.

The upper phase was in each case admixed with 3-pentenenitrile and heated at 100° C. for 48 h. After the heating, the content of intact ligand 1 was determined by means of ³¹P NMR.

The results are compiled in Table 1.

TABLE 1
Extraction with adiponitrile

| | | | | | | | Ligand 1 |
|---|---|---|---|---|---|---|---|
| | | Methylimidazole | Methylimidazole | | | Ligand 1 | content |
| | Mass | hydrochloride | hydrochloride | Methylimidazole | Methylimidazole | content | after heating |
| | (g) | (ppm) | (mg) | (GC %) | (g) | [%] | [%] |
| Crude | 600 | 820 | 492 | 1.72 | 10.32 | 95 | |
| ligand | | | | | | | |
| 1st upper | 1212.2 | 82 | 99 | 0.373 | 4.52 | | 51 |
| phase | | | | | | | |
| 2nd upper | 1191 | 45 | 53 | 0.077 | 0.92 | | 79 |
| phase | | | | | | | |
| 3rd upper | 1181.3 | 30 | 35 | — | — | | 91 |
| phase | | | | | | | |
| 4th upper | 1168.2 | 24 | 28 | — | — | | 92 |
| phase | | | | | | | |
| 5th upper | 1157.3 | 20 | 23 | — | — | | 93 |
| phase | | | | | | | |
| 6th upper | 1145.5 | 20 | 23 | — | — | | 93 |
| phase | | | | | | | |
| 1st lower | 47.8 | 3900 | 186 | 8.924 | 4.27 | | |
| phase | | | | | | | |
| 2nd lower | 81.2 | 3000 | 243 | 4.606 | 3.74 | | |
| phase | | | | | | | |
| 3rd lower | 69.7 | 1100 | 77 | 2.001 | 1.39 | | |
| phase | | | | | | | |
| 4th lower | 73.1 | 440 | 32 | 0.807 | 0.60 | | |
| phase | | | | | | | |
| 5th lower | 70.9 | 120 | 9 | 0.310 | 0.22 | | |
| phase | | | | | | | |
| 6th lower | 71.8 | 32 | 2 | 0.063 | 0.05 | | |
| phase | | | | | | | |
| | | | 549 | | 10.3 | | |

### Example 2

### Extraction with Methylglutaronitrile and Subsequent Heating of Ligand 1

The procedure was analogous to Example 1 with methylglutaronitrile instead of adiponitrile.

The results are compiled in Table 2.

TABLE 2
Extraction with methylglutaronitrile

| | | | | | | | Ligand 1 |
|---|---|---|---|---|---|---|---|
| | | Methylimidazole | Methylimidazole | | | Ligand 1 | content |
| | Mass | hydrochloride | hydrochloride | Methylimidazole | Methylimidazole | content | after heating |
| | (g) | (ppm) | (mg) | (GC %) | (g) | [%] | [%] |
| Crude | 600 | 820 | 492 | 1.94 | 11.6 | 94 | |
| ligand | | | | | | | |
| 1st upper | 1219 | 22 | 27 | 0.40 | 4.9 | | 76 |
| phase | | | | | | | |
| 2nd upper | 1200 | 19 | 23 | 0.14 | 1.7 | | 85 |
| phase | | | | | | | |
| 3rd upper | 1185 | 19 | 23 | 0.03 | 0.4 | | 91 |
| phase | | | | | | | |
| 4th upper | 1169 | 20 | 23 | — | — | | 92 |
| phase | | | | | | | |
| 5th upper | 1157 | 17 | 20 | — | — | | 92 |
| phase | | | | | | | |
| 6th upper | 1143 | 17 | 19 | — | — | | 92 |
| phase | | | | | | | |
| 1st lower | 41 | 8000 | 328 | 8.90 | 3.6 | | |
| phase | | | | | | | |
| 2nd lower | 79 | 2200 | 174 | 4.51 | 3.6 | | |
| phase | | | | | | | |
| 3rd lower | 75 | 360 | 27 | 2.14 | 1.6 | | |
| phase | | | | | | | |
| 4th lower | 76 | 56 | 4 | 1.01 | 0.8 | | |
| phase | | | | | | | |
| 5th lower | 72 | 12 | 1 | 0.46 | 0.3 | | |
| phase | | | | | | | |
| 6th lower | 74 | 7 | 1 | 0.22 | 0.2 | | |
| phase | | | | | | | |
| | | | 534 | | 10.1 | | |

### Example 3

### Stability of Ligand 2 in 3-Pentenenitrile

0.15 g of ligand 2 was dissolved in 3 g of 3-pentenenitrile, admixed with the amounts of methylimidazole visible from Table 3 and heated to 100° C. under an argon atmosphere in a heating block for 17 h, and the residual content of ligand 2 was determined by ³¹P NMR spectroscopy:

TABLE 3

| Methylimidazole | Residual content of ligand 2 |
|---|---|
| 1000 ppm | 0% |
| 500 ppm | 5% |
| 250 ppm | 18% |
| 125 ppm | 45% |
| 65 ppm | 68% |
| 35 ppm | 87% |

The results from Table 3 show that ligand 2 is sufficiently stable from a methylimidazole content of <100 ppm.

### Example 4

### Stability of Ligand 3 in 3-Pentenenitrile

0.15 g of ligand 3 was treated with 3 g of 3-pentenenitrile analogously to Example 3. The result was determined by ³¹p NMR spectroscopy and was compiled in Table 4:

TABLE 4

| | Residual chelate |
|---|---|
| Methylimidazole | ligand content |
| 1000 ppm | 55% |
| 65 ppm | 98% |

1. A process for purifying phosphorus chelate ligands comprising extracting and optionally phase separating phosphorus chelate ligands with polar extractants at temperatures of from (−20) to 150° C. and a pressure of from 1 to 5000 Pa.

2. The process for purifying phosphorus chelate ligands by extraction according to claim 1, wherein the phosphorus chelate ligands are bidentate phosphites, phosphinites, phosphite phosphinites, phosphite phosphonites and phosphonites.

3. The process for purifying phosphorus chelate ligands by extraction according to claim 1, wherein the temperature is at least 0° C.

4. The process for purifying phosphorus chelate ligands by extraction according to claim 1, wherein the temperature is at most 100° C.

5. The process for purifying phosphorus chelate ligands by extraction according to claim 1, wherein the pressure is at least 1 kPa.

6. The process for purifying phosphorus chelate ligands by extraction according to claim 1, wherein the pressure is at most 2000 Pa.

7. The process for purifying phosphorus chelate ligands by extraction according to claim 1, wherein the polar extractants are dinitriles.

8. The process for purifying phosphorus chelate ligands by extraction according to claim 1, wherein the polar extractant is adiponitrile or methylglutaronitrile.

9. The process for purifying phosphorus chelate ligands by extraction according to claim 1, wherein an aliphatic or cycloaliphatic hydrocarbon or a mixture thereof is added to the phosphorus chelate ligands before or during the extraction or the optional phase separation.

10. The process for purifying phosphorus chelate ligands by extraction according to claim 9, wherein the aliphatic or cycloaliphatic hydrocarbon added to the phosphorus chelate ligand before or during the extraction or phase separation is selected from the group consisting of n-heptane, n-octane, cyclohexane, methylcyclohexane and mixtures thereof.

11. The process for purifying phosphorus chelate ligands by extraction according to claim 1, wherein the purified phosphorus chelate ligands have a content of amine base, amine hydrochloride or mixtures thereof of less than 100 ppm.

12. The process for purifying phosphorus chelate ligands by extraction according to claim 2, wherein the temperature is at least 0° C.

13. The process for purifying phosphorus chelate ligands by extraction according to claim 2, wherein the temperature is at most 100° C.

14. The process for purifying phosphorus chelate ligands by extraction according to claim 3, wherein the temperature is at most 100° C.

15. The process for purifying phosphorus chelate ligands by extraction according to claim 2, wherein the pressure is at least 1 kPa.

16. The process for purifying phosphorus chelate ligands by extraction according to claim 3, wherein the pressure is at least 1 kPa.

17. The process for purifying phosphorus chelate ligands by extraction according to claim 4, wherein the pressure is at least 1 kPa.

18. The process for purifying phosphorus chelate ligands by extraction according to claim 2, wherein the pressure is at most 2000 Pa.

19. The process for purifying phosphorus chelate ligands by extraction according to claim 3, wherein the pressure is at most 2000 Pa.

20. The process for purifying phosphorus chelate ligands by extraction according to claim 4, wherein the pressure is at most 2000 Pa.
